(19) United States
(12) Patent Application Publication
(10) Pub. No.: US 2002/0069564 A1
(43) Pub. Date: Jun. 13, 2002

(54) Tamper proof license plate

(76) Inventor: Jong Won Yoon, Pusan (KR)

Correspondence Address: Eugene Oak, 610 S. Van Ness Ave., Los Angeles, CA, 90005, US

(21) Appl. No.: 09/757,674

(22) Filed: Jun. 7, 2001

(30) Foreign Application Priority Data
Dec. 13, 2000 (KR) 30607

(51) Int. Cl. G09F 7/00

(52) U.S. Cl. 40/202

(57) ABSTRACT

A tamper-proof license plate with means for attaching to car bumper that renders it irremovable without destroying said license plate. This is accomplished by perforating its main body so hat he entire assembly will break into a plurality of pieces when anyone attempts to pull it off. The present invention also provides a means for tracking stolen license plate if necessary through a set of identifying information written on a special washer placed between the bumper and the license plate.

### FIELD OF THE INVENTION

The present invention generally relates to a license plate which is made to be tamper proof by furnishing it with means for attaching to car bumper that renders it irremovable without destroying said license plate. This is accomplished by perforating its main body so that the entire assembly will break into a plurality of pieces when anyone attempts to pull it off. The present invention also teaches a means for tracking stolen license plate, if necessary, through a set of identifying information written on a special washer placed between the bumper and the license plate.

### BACKGROUND OF THE INVENTION

Many protective devices for security of automobiles exist on the market today. Car license plate theft is very common. Car owners practice such safety measures as installation of car alarms that are sensitive to a motion on a car body. However, this sort of equipment is very costly and is ineffective in many cases where the alarm is not heard, disabled or ignored by others currently, there exists no device in the market, which is used solely to prevent someone from taking the license plate. Instead of making it difficult to do so, the present invention makes it totally useless for anyone to try since nobody can successfully remove the license plate from the bumper if made using this method of construction.

### BRIEF DESCRIPTION OF THE DRAWINGS

For a better understanding of the nature of the present invention, reference should be made to the following detailed description taken in connection with the accompanying drawings wherein:

FIG. 1 is a perspective view of the front side of he license plate.

FIG. 2 is a perspective view of the backside of the license plate as it would be attached to the bumper panel.

FIG. 3 is a top view of the license plate in connection with the bumper attachment panel.

FIG. 4 is a cross sectional view of the connection between the license plate and the bumper attachment panel, showing the washers with the identification inscription.

FIG. 4a is an enlargement of the view in FIG. 4 focusing on the washer's elements.

### DETAILED DESCRIPTION OF THE PREFERRED EMBODIMENT

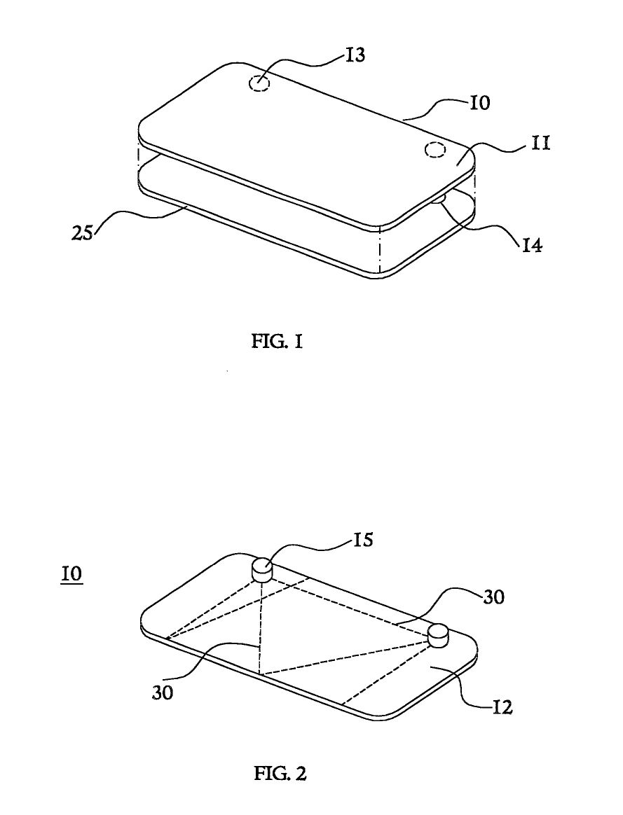

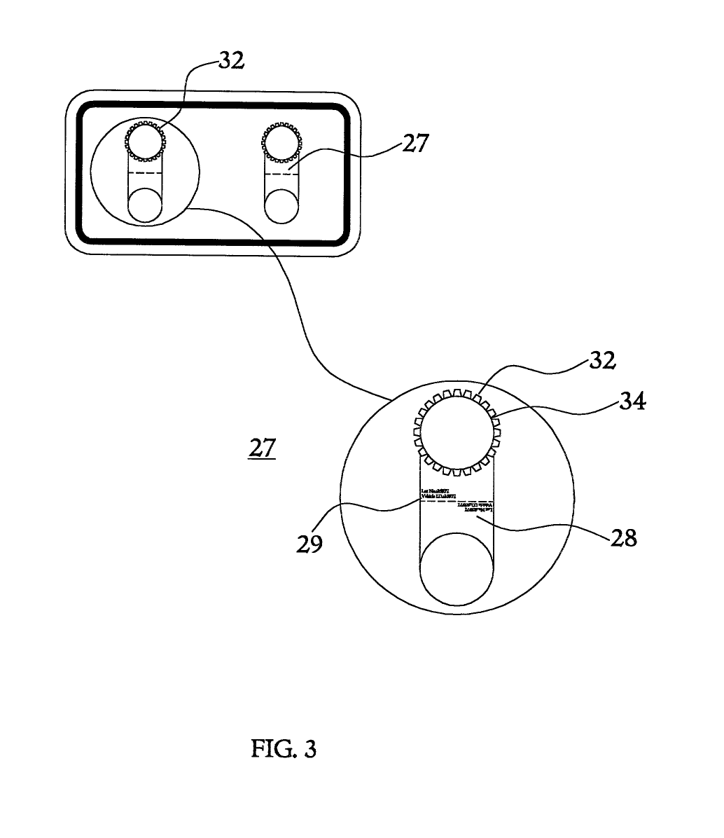

Referring now to FIG. 1 and FIG. 2, the preferred embodiment of the present invention is a license plate, generally referred to as 10 and attachment assembly comprising a relatively flat rectangular front surface 11 bearing the license plate number. Opposite to 11 is a relatively flat back surface 12 with two raised cylindrical hollow pegs 15 which make contact between the bumper of the car, generally referred to as 25, and the plate's back surface 12. Said pegs are located towards the four corners of the back surface 12, each peg 15 being at one of the four corners. Said back surface has a plurality of perforation lines 30 extending from a point at one edge of the plate to where said pegs are integrally joined to the plate. This ensures that any great amount of pressure applied to the pegs 15 would cause the plate to break at perforated lines 30. Therefore when anyone tries to remove the plate from the bumper of the car, the plate will break int many pieces rendering it unusable.

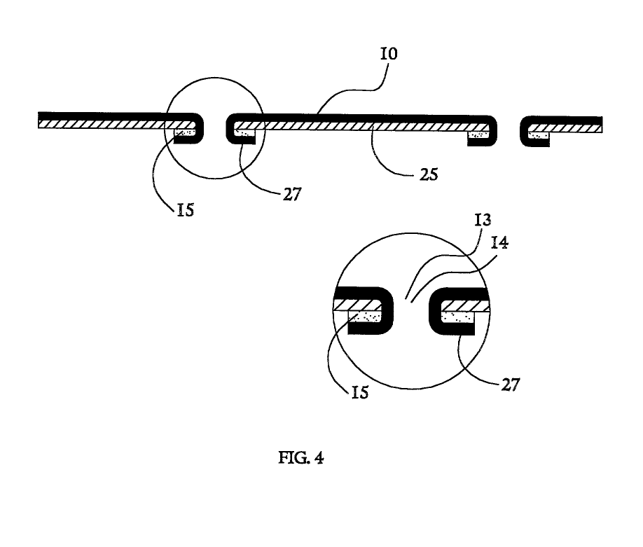

FIG. 3 shows the present invention as it would appear while in use on an automobile. License plate 10 is represented by the thick dark lines that curve at the ends. The cross-stitched area represents the bumper 25. Plate 10 has two openings 13 where the flat aluminum surface has been punctured and folded into the back surface 12. Openings 13 are relatively circular in shape and small enough to allow for the uninterrupted reading of he license plate number on front surface 11. The folded back portion forms a washer 27 which can be inserted into a hole 14 on the car bumper 25 which is of similar size to hole 13. Opening mechanism 32 of car bumper 25 is constructed of many strips 34 of aluminum radially disposed with respect to hole 14. The strips have a small amount of space in between and are slightly bent to allow expansion in overall radius of opening when pressure is applied evenly to its surface. Accordingly, washer 27 may be inserted into the bumper's opening by squeezing opening 32's strips 34 together and creating more space in the center. Once washer 27 has been wholly inserted through the opening, however, the strips extend themselves and wrap around the underside of washer 27. When this action has been accomplished, the strips on opening 32 can never be compressed again since it is being pressed on both sides by washer 27 and back side 12 of plate 10. Forming an integral part of the washer are the pegs that create a buffer between the washer and the bumper. Washer 27 is connected to the plate 10, therefore, the plate is now securely attached to the bumper with the washers preventing it from coming off.

FIG. 4 shows the configuration of the washer and the plate with respect to the bumper at another angle. Each washer 27 is connected to flat panel 29, which is connected to the backside 12 of plate 10. Panel 28 is vertically disposed at the two ends of the plate. Lot number and vehicle registration information as well as other identifying marks 29 are placed on the surface of panel 28 two times. At the midsection of panel 28 is a perforated line 33 horizontally disposed and separating the two sets of vehicle identification mark 29. Mark 29 located above the perforation line 33 will remain attached to washer 27, which is inserted into flexible opening 32. The other set of identification marks 29 located under perforation line 33 will remain attached to the license plate even if it is removed somehow.

It is an object of the present invention to maintain ability to identify vehicle even when the plate has been removed. It is another object of the present invention to deter possible theft of the license plate since the plate will break at any attempt to remove it. It is yet another object of the present invention that a stolen license plate not be reusable.

What is claimed is:

1. Tamper-proof license plate comprising a plate and an adapting bumper portion which fit together,

2. License plate according to claim 1 wherein sad plate has perforation lines on is surface and such lines are strategically placed as to cause the plate to break into many pieces if pried apart from the bumper.

3. License plate according to claim 1 wherein said plate has a male component washer fitting into a female component opening on the bumper and means or locking it together so that the license plate cannot be removed from the bumper without disturbing the integrity of the plate.

4. License plate according to claim 1 wherein plate has special washer designed to contain information in two identical sets so that if plate is removed, the two sets of identifying marks will be separated as well.
